(19) United States
(12) Patent Application Publication
(10) Pub. No.: US 2012/0218207 A1
(43) Pub. Date: Aug. 30, 2012

(54) ELECTRONIC DEVICE, OPERATION CONTROL METHOD, AND STORAGE MEDIUM STORING OPERATION CONTROL PROGRAM

(75) Inventors: Takayuki SATO, Yokohama-shi (JP); Makiko HOSHIKAWA, Osaka (JP); Tomohiro SHIMAZU, Osaka (JP)

(73) Assignee: KYOCERA CORPORATION, Koyoto (JP)

(21) Appl. No.: 13/404,138

(22) Filed: Feb. 24, 2012

(30) Foreign Application Priority Data
Feb. 24, 2011 (JP) 2011-039093

(51) Int. Cl. G06F 3/041

(52) U.S. Cl. 345/173

(57) ABSTRACT

According to an aspect, an electronic device includes a display unit, an operation detecting unit, and a control unit. The display unit displays a first object. The operation detecting unit detects an operation. When a slide operation is detected by the operation detecting unit while the first object is displayed on the display unit, the control unit causes a second object associated with a layer below the first object to be displayed on the display unit.

### CROSS-REFERENCE TO RELATED APPLICATIONS

This application claims priority from Japanese Application No. 2011-039093, filed on Feb. 24, 2011, the content of which is incorporated by reference herein in its entirety.

### BACKGROUND

1. Technical Field

The present disclosure relates to an electronic device, an operation control method, and a storage medium storing therein an operation control program.

2. Description of the Related Art

Recently, in order to allow an intuitive operation and realize a small-size electronic device that does not include a device requiring a physically large area such as a keyboard, touch panels are widely used. In an electronic device that includes a touch panel, a specific process is assigned to an operation such as a tap operation that is detected by a touch panel (for example, Japanese Patent Application Laid-Open No. 2009-164794).

However, operations that are detected by the touch panel are no more than several kinds such as a tap operation, a flick operation, and a sweep operation. Accordingly, in conventional electronic devices that include touch panels, various operation methods cannot be given to users.

For the foregoing reasons, there is a need for an electronic device, an operation control method, and an operation control program capable of providing a user with various operation methods.

### SUMMARY

According to an aspect, an electronic device includes a display unit, an operation detecting unit, and a control unit. The display unit displays a first object. The operation detecting unit detects an operation. When a slide operation is detected by the operation detecting unit while the first object is displayed on the display unit, the control unit causes a second object associated with a layer below the first object to be displayed on the display unit.

According to another aspect, an operation control method is executed an electronic device including a display unit and an operation detecting unit. The operation control method includes: displaying a first object on the display unit; detecting a slide operation by the operation detecting unit; and causing, when a slide operation is detected by the operation detecting unit while the first object is displayed on the display unit, a second object associated with a layer below the first object to be displayed on the display unit.

According to another aspect, a non-transitory storage medium stores therein an operation control program. When executed by an electronic device that includes a display unit and an operation detecting unit, the operation control program causes the electronic device to execute: displaying a first object on the display unit; detecting a slide operation by the operation detecting unit; and causing, when a slide operation is detected by the operation detecting unit while the first object is displayed on the display unit, a second object associated with a layer below the first object to be displayed on the display unit.

### BRIEF DESCRIPTION OF THE DRAWINGS

FIG. 1 is a perspective view of a mobile phone;

FIG. 2 is a front view of the mobile phone;

FIG. 3 is a block diagram of the mobile phone;

FIG. 4 is a diagram illustrating an example of control executed by a control unit according to an operation detected by a contact sensor;

FIG. 5 is a flowchart illustrating an operation of the mobile phone; and

FIG. 6 is a flowchart illustrating an operation of the mobile phone.

### DETAILED DESCRIPTION

The present invention will be described in detail with reference to the drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone is used to explain as an example of the electronic device, however, the present invention is not limited to mobile phones. Therefore, the present invention can be applied to various types of devices (portable electronic devices and/or stationary electronic devices), including but not limited to personal handyphone systems (PHS), personal digital assistants (PDA), portable navigation units, personal computers (including but not limited to tablet computers, netbooks etc.), media players, portable electronic reading devices, and gaming devices.

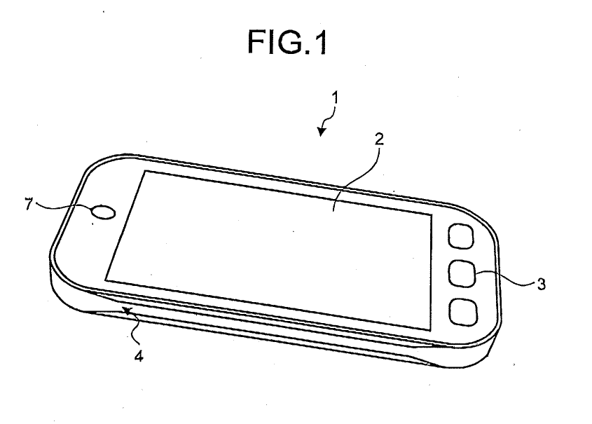

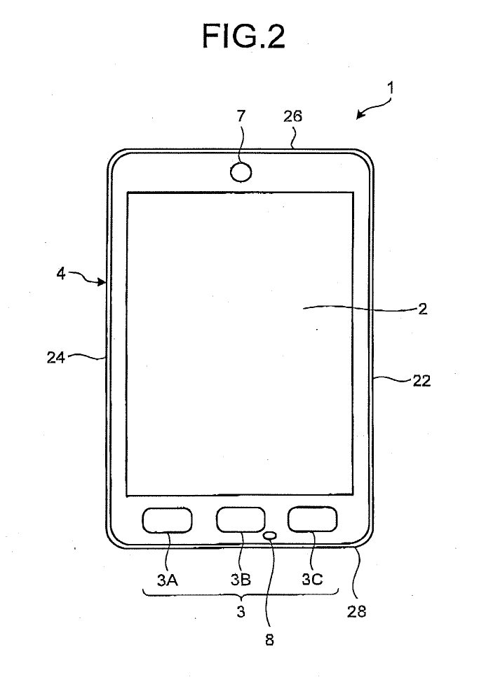

First, an overall configuration of a mobile phone 1 as an electronic device according to an embodiment will be described with reference to FIGS. 1 and 2. FIG. 1 is a perspective view of the mobile phone 1. FIG. 2 is a front view of the mobile phone 1. As illustrated in FIGS. 1 and 2, the mobile phone 1 includes a housing that has an approximately hexahedral shape having two faces the area of which is larger than the other faces, and a touch panel 2, an input unit 3, a contact sensor 4, a speaker 7, and a microphone 8, which are arranged on the surface of the housing.

The touch panel 2 is disposed on one of faces (a front face or a first face) having the largest area. The touch panel 2 displays a text, a graphic, an image, or the like, and, detects various operations (gestures) performed by a user on the touch panel 2 by using his/her finger, a stylus, a pen, or the like (in the description herein below, for the sake of simplicity, it is assumed that the user touches the touch panel 2 with his/her fingers). The detection method of the touch panel 2 may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. The input unit 3 includes a plurality of buttons such as a button 3A, a button 3B, and a button 3C to which predetermined functions are assigned. The speaker 7 outputs a voice of a call opponent, music or an effect sound reproduced by various programs, and the like. The microphone 8 acquires a voice during a phone call or upon receiving an operation by a voice.

The contact sensor 4 is disposed on a face (a side face, a second face) that comes into contact with the face on which the touch panel 2 is disposed. The contact sensor 4 detects various operations that the user performs for the contact sensor 4 by using his/her finger. Under the assumption that the face on which the touch panel 2 is disposed is the front face, the contact sensor 4 includes the right contact sensor 22 disposed on the right side face, the left contact sensor 24 disposed on the left side face, the upper contact sensor 26 disposed on the upper side face, and the lower contact sensor 28 disposed on the lower side face. The detection method of the right contact sensor 22 and the like may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. Each of the right contact sensor 22, the left contact sensor 24, the upper contact sensor 26, and the lower contact sensor 28 can detect a multi-point contact. For example, when two fingers are brought into contact with the right contact sensor 22, the right contact sensor 22 can detect respective contacts of the two fingers at the positions with which the two fingers are brought into contact.

The mobile phone 1 includes the contact sensor 4 in addition to the touch panel 2 and thus can provide the user with various operation methods that are intuitive and superior in operability as will be described below.

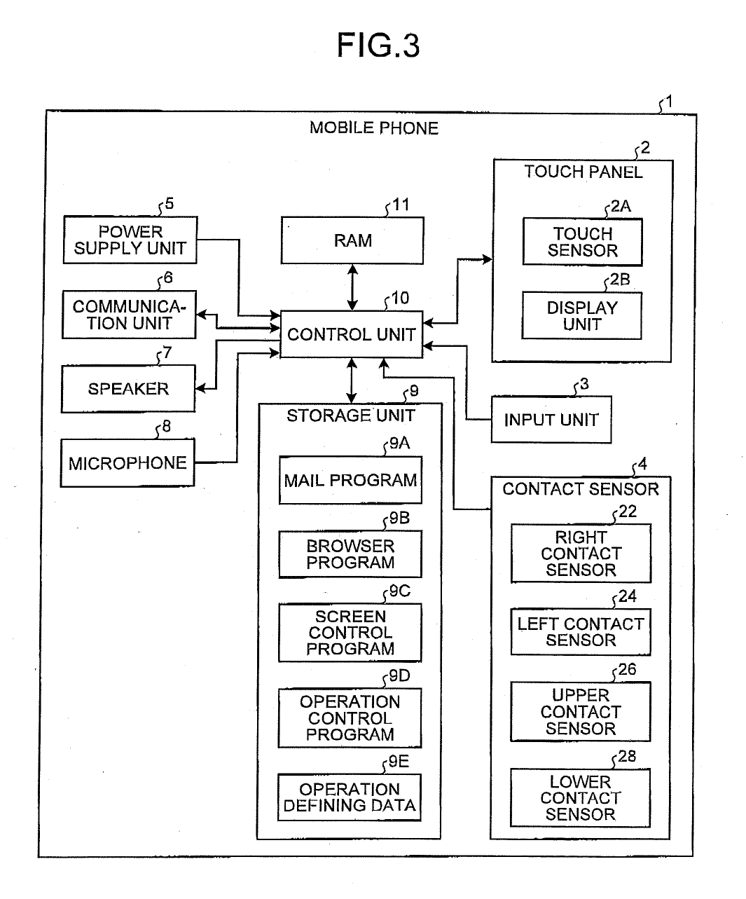

Next, a functional configuration of the mobile phone 1 will be described with reference to FIG. 3. FIG. 3 is a block diagram of the mobile phone 1. As illustrated in FIG. 3, the mobile phone 1 includes the touch panel 2, the input unit 3, the contact sensor 4, a power supply unit 5, a communication unit 6, the speaker 7, the microphone 8, a storage unit 9, a control unit 10, and a random access memory (RAM) 11.

The touch panel 2 includes a display unit 2B and a touch sensor 2A that is arranged on the display unit 2B in a superimposed manner. The touch sensor 2A detects various operations performed on the touch panel 2 using the finger as well as the position on the touch panel 2 at which the operation is made and notifies the control unit 10 of the detected operation and the detected position. Examples of the operations detected by the touch sensor 2A include a tap operation and a sweep operation. The display unit 2B is configured with, for example, a liquid crystal display (LCD), an organic electro-luminescence display (OELD), or the like and displays a text, a graphic, and so on.

The input unit 3 receives the user's operation through a physical button or the like and transmits a signal corresponding to the received operation to the control unit 10. The contact sensor 4 includes the right contact sensor 22, the left contact sensor 24, the upper contact sensor 26, and the lower contact sensor 28. The contact sensor 4 detects various operations performed on these sensors as well as the positions at which the operations are made, and notifies the control unit 10 of the detected operation and the detected position. The power supply unit 5 supplies electric power acquired from a battery or an external power supply to the respective functional units of the mobile phone 1 including the control unit 10.

The communication unit 6 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 6. The speaker 7 outputs a sound signal transmitted from the control unit 10 as a sound. The microphone 8 converts, for example, the user's voice into a sound signal and transmits the converted sound signal to the control unit 10.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.), and stores therein programs and data used for processes performed by the control unit 10. The programs stored in the storage unit 9 include a mail program 9A, a browser program 9B, a screen control program 9C, and an operation control program 9D. The data stored in the storage unit 9 includes operation defining data 9E. In addition, the storage unit 9 stores programs and data such as an operating system (OS) program for implementing basic functions of the mobile phone 1, address book data, and the like. The storage unit 9 may be configured with a combination of a portable storage medium such as a memory card and a storage medium reading device.

The mail program 9A provides a function for implementing an e-mail function. The browser program 9B provides a function for implementing a web browsing function. The screen control program 9C displays a text, a graphic, or the like on the touch panel 2 in cooperation with functions provided by the other programs. The operation control program 9D provides a function for executing processing according to various contact operations detected by the touch sensor 2A and the contact sensor 4. The operation defining data 9E maintains a definition on a function that is activated according to a detection result of the contact sensor 4.

The control unit 10 is, for example, a central processing unit (CPU) and integrally controls the operations of the mobile phone 1 to realize various functions. Specifically, the control unit 10 implements various functions by executing a command included in a program stored in the storage unit 9 while referring to data stored in the storage unit 9 or data loaded to the RAM 11 as necessary and controlling the display unit 2B, the communication unit 6, or the like. The program executed or the data referred to by the control unit 10 may be downloaded from a server apparatus through wireless communication through the communication unit 6.

For example, the control unit 10 executes the mail program 9A to implement an electronic mail function. The control unit 10 executes the operation control program 9D to implement a function for performing corresponding processing according to various contact operations detected by the touch sensor 2A and the contact sensor 4. The control unit 10 executes the screen control program 9C to implement a function for displaying a screen and the like used for various functions on the touch panel 2. In addition, it is assumed that the control unit 10 can execute a plurality of programs in a parallel manner through a multitasking function provided by the OS program.

The RAM 11 is used as a storage area in which a command of a program executed by the control unit 10, data referred to by the control unit 10, a calculation result of the control unit 10, and the like are temporarily stored.

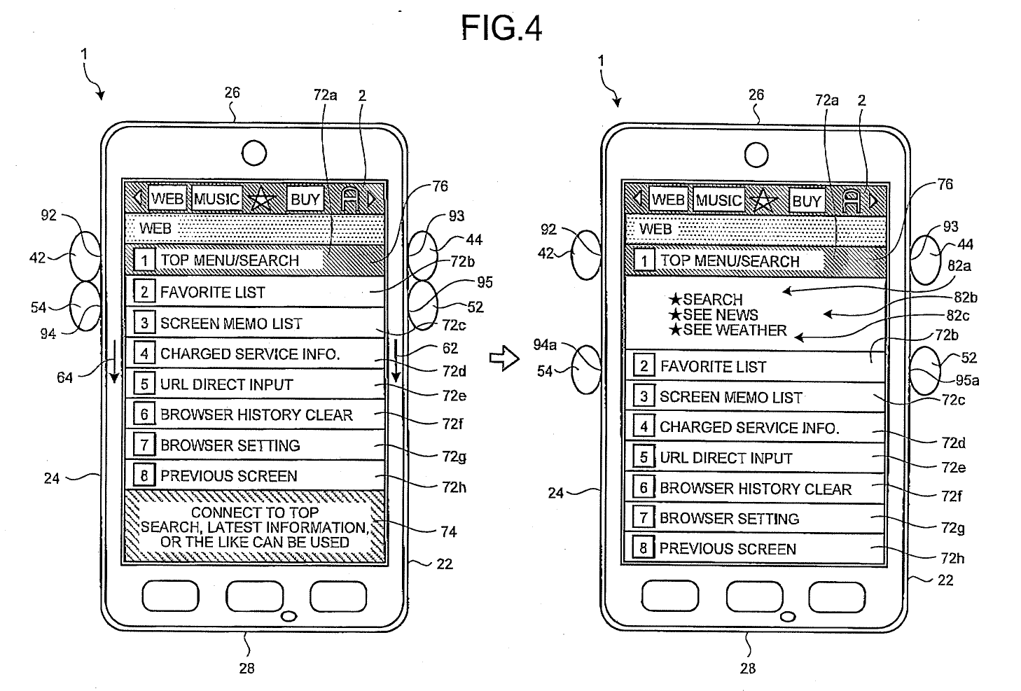

Next, an example of control executed by the control unit 10 according to an operation detected by the contact sensor 4 will be described with reference to FIG. 4. FIG. 4 is a diagram illustrating an example of control executed by the control unit 10 according to an operation detected by the contact sensor 4. FIG. 4 is a diagram schematically illustrating a relation among, the contact sensor 4, a screen of an operation target, and the fingers. In FIG. 4, a housing portion of the outer circumference of the touch panel 2 is not illustrated.

The mobile phone 1 illustrated in FIG. 4 is supported by the user's right hand and left hand in a direction in which a longitudinal direction of the touch panel 2 is a lengthwise direction (a vertical direction). In the present embodiment, the user supports a portion of the left contact sensor 24 at the upper contact sensor 26 side with a left thumb 42 and supports a portion of the right contact sensor 22 at the upper contact sensor 26 side with a left index finger 44. Further, the user supports a portion of the right contact sensor 22 at the lower contact sensor 28 side with a right thumb 52 and supports a portion of the left contact sensor 24 at the lower contact sensor 28 side with a right index finger 54.

In a state in which support is made with the four fingers as described above, in the mobile phone 1, a contact at a contact point 92 of the thumb 42 is detected by the left contact sensor 24, a contact at a contact point 93 of the index finger 44 is detected by the right contact sensor 22, a contact at a contact point 94 of the index finger 54 is detected by the left contact sensor 24, and a contact at a contact point 95 of the thumb 52 is detected by the right contact sensor 22 as illustrated in the left drawing of FIG. 4. That is, the right contact sensor 22 detects the contacts at the two points, that is, the contact point 93 and the contact point 95. The left contact sensor 24 detects the contacts at the two points, that is, the contact point 92 and the contact point 94. The contact point 92 and the contact point 93 are substantially the same in the position in the longitudinal direction (a long side direction of the touch panel 2 or a direction in which the right contact sensor 22 and the left contact sensor 24 extend). The contact point 94 and the contact point 95 are substantially the same in the position in the longitudinal direction. Thus, the contact point 92 and the contact point 93 can be connected to each other by a straight line parallel to a traverse direction (a short side direction of the touch panel 2 or a direction in which the upper contact sensor 26 and the lower contact sensor 28 extend), and the contact point 94 and the contact point. 95 are also connected to each other by a straight line parallel to the traverse direction. The straight lines preferably pass through near the corresponding contact points, respectively. In other words, preferably, the positions of the contact points can be approximated to connect to each other by a straight line parallel to the traverse direction. In the present embodiment, the straight line connecting the two contact points is referred to as a contact position.

In the state illustrated in the left drawing of FIG. 4, a plurality of objects (items) are displayed on the touch panel 2. Specifically, 8 objects, i.e., objects 72a to 72h are arranged in a line from an upper side of a screen toward a lower side. A message 74 is displayed below the object 72h on the touch panel 2. A cursor 76 representing a user's operation target is also displayed. The cursor 76 is in a state designating the object 72a and displayed on the object 72a in a superimposed manner.

In the state illustrated in the left drawing of FIG. 4, the thumb 52 is slidingly moved in a direction of an arrow 62, and the index finger 54 is slidingly moved in a direction of an arrow 64. That is, the thumb 52 contacting the left contact sensor 24 is moved in a direction away from the index finger 44 (slide movement). Further, the index finger 54 contacting the right contact sensor 22 is moved in a direction away from the thumb 42. By moving the fingers as described above, the user moves the index finger 54 to a contact point 94a and moves the thumb 52 to a contact point 95a as illustrated in the right drawing of FIG. 4. Hereinafter, an operation of slidingly changing a distance between the fingers contacting the contact sensor 4 by slide movement (an operation of changing a distance between the contact positions) as illustrated from the left drawing to the right drawing of FIG. 4 may be referred to as a “hierarchical display operation”. The hierarchical display operation includes a plurality of modes to be performed, and FIG. 4 illustrates one of the modes in which a slide operation for increasing a distance between the contact positions is performed on each of two sides.

When the hierarchical display operation is input, the left contact sensor 24 detects an operation for moving the contact point 94 to the contact point 94a, and the right contact sensor 22 detects an operation for moving the contact point 95 to the contact point 95a. The contact sensor 4 notifies the control unit 10 of the detection result.

The control unit 10 changes an image displayed on the touch panel 2 based on a function provided by the operation control program 9D when the operation for increasing the distance between the contacting fingers is detected by the contact sensor 4, that is, in the present embodiment, when an operation of separating the straight line (contact position), parallel to the transverse direction, approximated by a combination of contact points (contact points 92 and 93) among a plurality of contact points detected by the right contact sensor 22 and a plurality of contact points detected by the left contact sensor 24, which are opposite to each other, from the straight line (contact position), parallel to the transverse direction, approximated by another combination of contact points (contact points 94 and 95) is detected by the contact sensor 4. Specifically, the control unit 10 causes objects 82a, 82b, and 82c associated with the object 72a to be displayed on the touch panel 2 as illustrated in the right drawing of FIG. 4. The objects 82a, 82b, and 82c are objects associated with the object 72a, that is, objects of a layer below the object 72a. As described above, when the contact sensor 4 detects the operation for increasing the distance between the contact positions as the hierarchical display operation, the control unit 10 causes an object associated with a layer below an object specified by the cursor 76 to be displayed.

The control unit 10 causes the objects 82a, 82b, and 82c to be displayed below the object 72a and above object 72b and causes the objects 72b to 72h that has been displayed below the object 72a to be shifted down on the display unit. The control unit 10 does not display the message 74 that has been displayed below the lower side of the touch panel 2. That is, the control unit 10 causes the objects 62a, 82b, and 82c to be newly displayed below the object 72a, causes the other objects to be displayed at the shifted positions, and does not display a portion (the message 74) that goes out from the display area of the touch panel 2 by shifting the display positions down.

As described above, when the contact sensor 4 detects an operation for increasing the distance between the contact positions as the hierarchical display operation, the mobile phone 1 causes an object of a layer below a designated object among objects displayed on the touch panel 2 to be displayed. Thus, the user can check an object associated with a layer below an object by a simple operation. Further, when an operation of increasing the distance between the contact positions is input, an object of a lower layer which is a content of a corresponding object is displayed, and thus an operation feeling of an input operation can have a higher affinity with processing to be executed than an operation feeling of an operation of clicking an object. Accordingly, an intuitive operation can be implemented.

In the above embodiment, when the hierarchical display operation is input, an object (a second object) of a layer below an object (a first object) designated by the cursor 76 is displayed. However, the present invention is not limited thereto. Various methods and rules may be used as a method and rule of specifying an operation target object, that is, a target object for displaying an object of a lower layer.

The mobile phone 1 may specify the operation target object (the first object) based on either of the contact positions. For example, the mobile phone 1 may specify the operation target object based on the contact position at the upper side in a screen display direction (in a left-right direction in a paper plane of FIG. 4). Specifically, an object whose position in a direction parallel to the moving direction of the contact position overlaps the contact position at the upper side may be specified as the operation target object. In the example of FIG. 4, an object interposed between the contact point 92 and the contact point 93 may be specified as the operation target object. Alternatively, the mobile phone I may specify the operation target object based on the contact position at the lower side in the screen display direction. Specifically, an object whose position in a direction parallel to the moving direction of the contact position overlaps the contact position at the lower side may be specified as the operation target object. In the example of FIG. 4, an object interposed between the contact point 94 and the contact point 95 may be specified as the operation target object. Thus, by inputting a contact operation to the contact sensor 4 without operating a cursor or the like, the user can specify the operation target object and cause an object of a lower layer associated with the operation target object to be displayed.

The mobile phone 1 causes the object of the lower layer to be displayed at the position adjacent to the operation target object as in the present embodiment. By causing the object of the lower layer to be displayed at the position adjacent to the operation target object, a correspondence relation between the objects can be clarified, and the objects can be displayed to be intuitively easily understood by the user.

The mobile phone 1 causes the object of the lower layer to be displayed in a direction of increasing the distance between the contact positions (a finger moving direction) as in the present embodiment. Furthermore, the object of the lower layer is displayed in a line as in the present embodiment. In addition, the object of the lower layer is displayed together with the operation target object as in the present embodiment. Thus, a correspondence relation can be intuitively easily understood.

When any one of the two contact positions does not move, the mobile phone 1 may cause the object of the lower layer to be displayed from a non-moved contact position to a moved contact position side as in the present embodiment. That is, the object of the lower layer may be displayed on an area at a finger moving direction side. An object is displayed in a direction in which the user moves and pulls out the finger, and thus an operation which is intuitively easily understood can be implemented. In this case, in the example illustrated in FIG. 4, the contact position is moved down, and so the object of the lower layer is displayed below the operation target object. When the contact position is moved up, the object of the lower layer may be displayed above the operation target object.

The mobile phone 1 may not cause an object of a lower layer to be displayed from a non-moved contact position as a base point to a moved contact position side. For example, an object of a lower layer may be displayed on an area in which an operation target object has been displayed, by moving the operation target object. As described above, a base point for displaying an object may be moved.

As described above, the mode according to the present embodiment can be used as a mode for displaying an object of a lower layer, however, the present invention is not limited thereto. For example, an object of a lower layer may be displayed at the position separate from an operation target object, or an operation target object may not be displayed when an object of a. lower layer is displayed.

When there are a plurality of objects in a lower layer, the number of objects to be displayed may be changed according to an amount of change in a distance between contact positions. That is, as an amount of change in a distance between contact positions increases, the number of objects to be displayed preferably increases.

An operation detected as the hierarchical display operation is not limited to an input illustrated in FIG. 4. The control unit 10 may detect various operations for putting contact positions, which are bought into contact with the contact sensor 4, closer to each other as the hierarchical display operation. An operation defined as the hierarchical display operation may be defined in the operation defining data 9E in advance. That is, an operation for putting contact positions, which are bought into contact with the contact sensor 4, closer to each other may be defined as an operation other than the hierarchical display operation.

For example, in the above embodiment, one of contact positions is moved, however, both of contact positions may be moved. Further, in the above embodiment, the right contact sensor 22 and the left contact sensor 24 detect two contact points, respectively, and a straight line connecting the contact points is used as the contact position. However, either contact points of the upper contact sensor 26 or contact points of the lower contact sensor 28 may be used as one contact points.

As described above, the mobile phone 1 uses a straight line, which is obtained by approximating and connecting contact points detected by two opposite contact sensors of the contact sensor 4 and which is perpendicular to the contact sensors, as at least one of contact positions of the hierarchical display operation. Thus, various processes can be allocated to other operations that can be detected by the contact sensor 4.

The mobile phone 1 uses a straight line, which is obtained by connecting a contact point detected by one contact sensor with a contact point detected by the other contact sensor, as one of two contact positions and uses a straight line, which is obtained by connecting another contact point detected by one contact sensor with another contact point detected by the other contact sensor, as one of two contact positions as illustrated in FIG. 4. In this case, an operation of opening a lid of a box using two hands may be used as the hierarchical display operation, and the operation of opening the lid of the box may be associated with processing of seeing the content of the operation target object (a process of displaying an object of a lower layer). Thus, processing to be executed in response to an input operation can be intuitively easily understood.

Any one sensor of the contact sensor 4 may detect each of contacts of two points as a contact position. In this case, the mobile phone 1 detects an operation of changing a distance between contacts of two points detected by one contact sensor as the hierarchical display operation.

The control unit 10 may detect a hand holding the housing based on information of a contact detected by the contact sensor 4, extract only a contact of a hand not holding the housing, and determine whether or not an operation input from the contact is the hierarchical display operation. In this case, when an operation of increasing a distance between contact positions is detected from the contact of the hand not holding the housing, it is determined that the hierarchical display operation has been input, and so an object of a lower layer is displayed. As described above, an operation is determined in view of a hand that has input an operation, and thus more operations can be input.

In the above embodiment, each item of a hierarchical operation menu is used as an object, however, an object is not limited thereto. An object may be used in displaying various hierarchical data. For example, an object may be used in operating an explorer that manages hierarchical data. A method of displaying an object of a lower layer is not limited to displaying items. For example, when an object of a lower layer is an image, a preview of a corresponding image may be displayed.

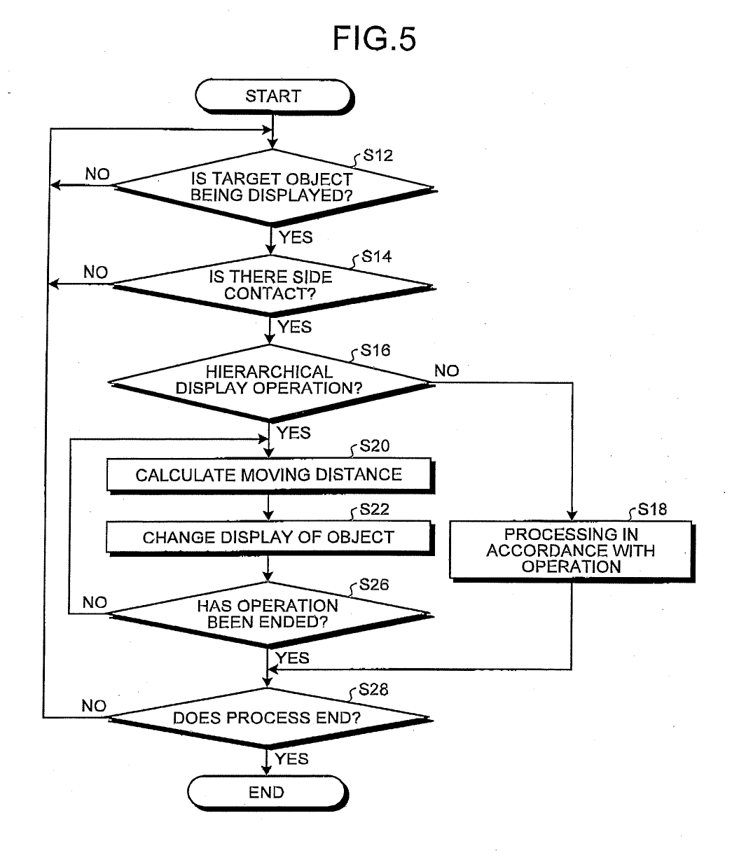

Next, an operation of the mobile phone 1 when a contact operation is detected will be described with reference to FIG. 5. FIG. 5 is a flowchart illustrating an operation of the mobile phone. A processing procedure illustrated in FIG. 5 is repetitively executed based on a function provided by the operation control program 9D.

At Step S12, the control unit 10 of the mobile phone 1 determines whether a target object is being displayed. The target object refers to an object which can be used as an operation target of the hierarchical display operation. When it is determined that the target object is not being displayed (No at Step S12), the control unit 10 proceeds to Step S12. That is, the control unit 10 repeats processing of Step S12 until the target object is displayed.

When it is determined that the target object is being displayed (Yes at Step S12), at Step S14, the control unit 10 determines whether there is a side contact, that is, whether a contact on any one side face has been detected by the contact sensor 4. When it is determined that there is no side contact (No at Step S14), that is, when it is determined that a contact on a side face has not been detected, the control unit 10 returns to Step S12. When it is determined that there is a side contact (Yes at Step S14), that is, when it is determined that a contact on a side face has been detected, at Step S16, the control unit 10 determines whether it is a hierarchical display operation.

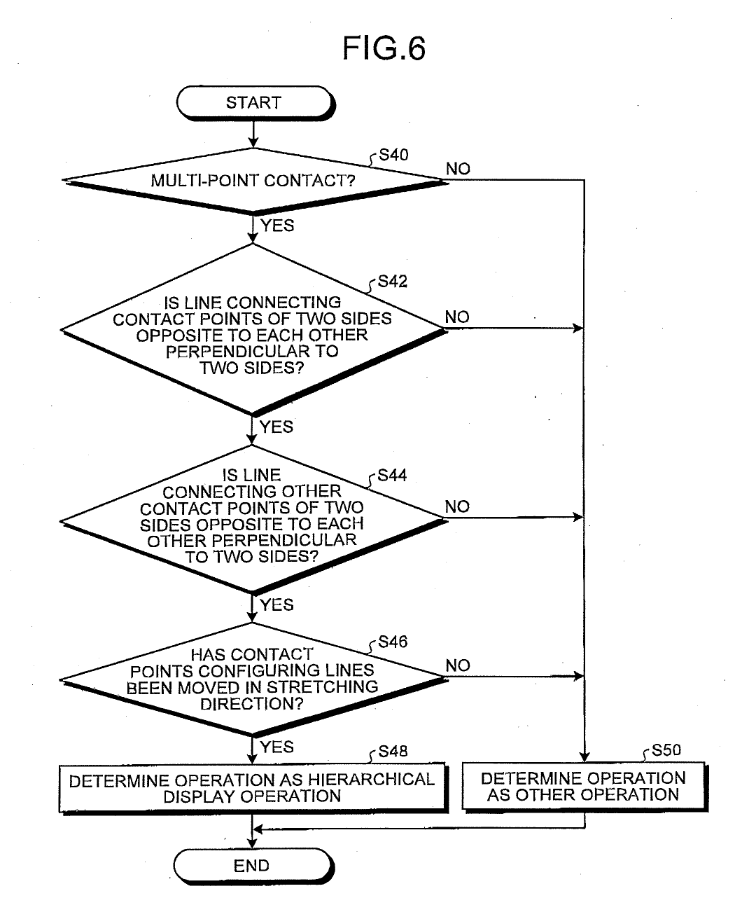

The determination of Step S16 will be described with reference to FIG. 6. FIG. 6 is a flowchart illustrating an operation of the mobile phone. The process illustrated in FIG. 6 is based on when the operation illustrated in FIG. 4 is defined as the hierarchical display operation. At Step S40, the control unit 10 determines whether the contact is a multi-point contact. That is, it is determined whether two or more contacts have been detected by the contact sensor 4. When it is determined that the contact is not the multi-point contact (No at Step S40), the control unit 10 proceeds to Step S50.

When it is determined that the contact is a multi-point contact (Yes at Step S40), at Step S42, the control unit 10 determines whether a line obtained by connecting contact points of corresponding two sides (two faces) to each other is a line that is substantially perpendicular to the two sides. In other words, it is determined whether contact points having a relation such that a line perpendicular to two sides passes through the approximated points thereof are present on opposite two sides. When it is determined that the contact points are not present (No at Step S42), the control unit 10 proceeds to Step S50.

When it is determined that the contact points are present (Yes at Step S42), at Step S44, the control unit 10 determines whether the line obtained by connecting other contact points of the corresponding two sides to each other is a line that is substantially perpendicular to the two sides. That is, it is determined whether other contact points having a relation such that a line perpendicular to two sides passes through the approximated points thereof are present on opposite two sides except the contact points determined at Step S42, When it is determined that the contact points are not present (No at Step S44), the control unit 10 proceeds to Step S50.

When it is determined that the contact points are present (Yes at Step S44), at Step S46, the control unit 10 determines whether the contact points configuring the line (contact position) that is substantially perpendicular to two sides have been moved in a stretching direction. When it is determined that the contact points have not been moved (No at Step S46), the control unit 10 proceeds to Step S50.

When it is determined that the contact points have been moved in the stretching direction (Yes at Step S46), at Step S48, the control unit 10 determines that the detected operation is the hierarchical display operation. When the determination result of Steps S40, S42, S44, or S46 is No, at Step S50, the control unit 10 determines that the detected operation is any other operation, that is, that the detected operation is not the hierarchical display operation. When the process of Step S48 or S50 is executed, the control unit 10 ends the present determination process. The control unit 10 may change the determination method according to an operation defined as the hierarchical display operation.

Returning to FIG. 5, the description of the present process is continued. When it is determined that the contact is not the hierarchical display operation (No at Step S16), at Step S18, the control unit 10 executes processing according to the input operation. The control unit 10 compares a correspondence relation stored in the operation defining data 9E with the input operation and specifies processing to be executed. Thereafter, the control unit 10 executes the specified processing and then proceeds to Step S28.

When it is determined that the contact is the hierarchical display operation (Yes at Step S16), at Step S20, the control unit 10 calculates a moving distance (slide distance) which is an amount of change in a separation distance between a contact point by a stopped finger and a contact point by a finger performing the slide operation. That is, an amount of change in a distance between one contact position and the other contact position is calculated. When the moving distance is calculated at Step S20, at Step S22, the control unit 10 changes a display of an object. Specifically, the control unit 10 specifies an operation target object from among displayed objects, and calculates the number of displayable objects of a lower layer based on the moving amount calculated at Step S20. Thereafter, the control unit 10 causes the objects of the layer below the operation target object to be displayed based on the calculated number of displayable objects. In the present embodiment, the moving distance is calculated, and then the number of displayable objects of a lower layer is calculated. However, all of objects of a layer below an operation target object specified may be displayed when the hierarchical display operation is detected.

After the process of Step S22 is performed, at Step S26, the control unit 10 determines whether the hierarchical display operation has been ended. The determination as to whether the hierarchical display operation has been ended can be made based on various criteria. For example, when a contact is not detected by the contact sensor 4, it can be determined that the hierarchical display operation has been ended.

When it is determined that the hierarchical display operation has not been ended (No at Step S26), the control unit 10 proceeds to Step S20. The control unit 10 repeats the display change process according to the moving distance until the hierarchical display operation ends. When it is determined that the hierarchical display operation has been ended (Yes at Step S26), the control unit 10 proceeds to Step S28.

When processing of Step S18 has been performed or when the determination result of Step S26 is Yes, at Step S28, the control unit 10 determines whether the process ends, that is, whether operation detection by the contact sensor 4 has ended. When it is determined that the process does not end (No at Step S28), the control unit 10 returns to Step S12. When it is determined that the process ends (Yes at Step S28), the control unit 10 ends the present process.

The mobile phone 1 according to the present embodiment is configured to receive an operation on a side face and execute processing according to the operation received at the side face, thereby providing the user with various operation methods. In other words, as illustrated in FIG. 5, when the contact detected by the contact sensor 4 is not the hierarchical display operation, by executing processing according to the input, various operations can be input. For example, processing of zooming in a displayed image or processing of scrolling screen may be performed on an operation of increasing a distance between two contact points detected by a contact sensor of one side (one face). Further, processing of displaying an object of a lower layer may be performed on an operation in which contact points are detected at corresponding positions (positions substantially perpendicular) of opposite two sides and a distance between contact positions obtained by connecting the contact points to each other is increased as in the operation illustrated in FIG. 4.

An aspect of the present invention according to the above embodiment may be arbitrarily modified in a range not departing from the gist of the present invention.

The above embodiment has been described in connection with the example of the operation of stretching the contact positions. When an operation opposite to the slide operation of stretching the contact positions, that is, an operation of shrinking the contact positions (an operation of putting the contact positions closer to each other) is input while an object of a lower layer is being displayed, the mobile phone 1 may end the displayed object of the lower layer, that is, may enter a state in which the object of the lower layer is not displayed. Thus, by inputting an operation opposite to an operation that has caused the object of the lower layer to be displayed, an original state can be returned, and thus an intuitive operation can be implemented. In this case, the mobile phone 1 may perform control such that the number of displayed objects of a lower layer is reduced based on a distance for narrowing the contact positions.

(The control unit 10 of) The mobile phone 1 may end a display of an object of a lower layer when a contact has not been detected by the contact sensor 4, in a state in which the object of the lower layer is displayed, during a predetermined time after a display of the object of the lower layer starts. Thus, when an operation is not input during a predetermined time in a state in which the object of the lower layer is displayed, an original state is automatically returned. Thus, the operation can easily proceed to a next operation. Further, since the object of the lower layer is displayed during a predetermined time, the object of the lower layer can be operated by operating the touch panel 2 with a finger that had made contact with the contact sensor 4. When a contact of a contact position has not been detected by the contact sensor 4 in a state in which the object of the lower layer is displayed, that is, when it becomes a state in which the user does not come into contact with the contact sensor 4, the mobile phone 1 may end a display of the object of the lower layer. As described above, when the user stops the contact of the hierarchical display operation, that is, when a hand is away separated from the contact sensor 4, by returning a display to an original state, the operation can easily proceed to a next operation.

In the above embodiment, the contact sensors are arranged on four sides (four side faces) of the housing as the contact sensor 4, however, the present invention is not limited thereto. The contact sensor that detects a contact on a side face may be arranged at a necessary position. For example, when the process of FIG. 4 is performed, the contact sensors may be arranged only on opposite two sides (two faces). In this case, the two contact sensors may be arranged on two side faces (that is, of long sides) adjacent to the long side of the front face (the face on which the touch panel is arranged). Thus, movement of the finger described with reference to FIG. 4 can be used as the hierarchical display operation, an operation can be easily input, and thus operability can be improved.

The above embodiment has been described in connection with the example in which the present invention is applied to an electronic device having a touch panel as a display unit. However, the present invention can be applied to an electronic device including a simple display panel on which a touch sensor is not superimposed.

In the present embodiment, the contact sensor 4 is used as a contact detecting unit, however, the contact detecting unit is not limited thereto. Any detecting unit that is installed on a predetermined area on the housing corresponding to a display unit and is configured to detect an operation on the corresponding area may be used as the contact detecting unit. Accordingly, the touch sensor 2A of the touch panel 2 may be used as the contact detecting unit. In other words, when an operation of increasing a distance between contact positions defined as the hierarchical display operation is input to the touch panel 2, an object of a lower layer may be displayed.

In the present embodiment, since various operations can be allocated to other operations and a more intuitive operation can be implemented, an operation of stretching contact positions, specifically, a first operation on a first position (contact position) of a predetermined area and a slide operation in a direction away from the first position (a slide operation of the other contact position) are used as the hierarchical display operation. However, the present invention is not limited thereto. The hierarchical display operation may be an operation including a slide operation of moving contact points or may be a slide operation of moving one contact point.

The advantages are that one embodiment of the invention provides an electronic device, an operation control method, and an operation control program capable of providing a user with various operation methods.

What is claimed is:

1. An electronic device, comprising:
a display unit for displaying a first object;
an operation detecting unit for detecting an operation; and
a control unit for causing, when a slide operation is detected by the operation detecting unit while the first object is displayed on the display unit, a second object associated with a layer below the first object to be displayed on the display unit.

2. The electronic device according to claim 1,
wherein the control unit is configured to causes the second object to be displayed when an operation on a position and the slide operation in a direction away from the position are detected by the operation detecting unit.

3. The electronic device according to claim 1,
wherein the operation detecting unit is provided on an area corresponding to the display unit and configured to detect an operation on the area.

4. The electronic device according to claim 1, further comprising a housing having a first face, on which the display unit is arranged, and second and third faces interposing the first face therebetween,
wherein the operation detecting unit is arranged on the second face.

5. The electronic device according to claim 4,
wherein the operation detecting unit includes a first detecting unit arranged the first face and a second detecting unit arranged on the third face, and
the control unit is configured to cause the second object to be displayed when the slide operation is detected by the first detecting unit and the second detecting unit.

6. The electronic device according to claim 5,
wherein the control unit is configured to perform process other than causing the second object to be displayed when the slide operation is detected by either of the first detecting unit or the second detecting unit.

7. The electronic device according to claim 3,
wherein the display unit is configured to display a plurality of objects, and
the control unit is configured to specify, when the slide operation is detected by the operation detecting unit while a plurality of objects are displayed on the display unit, the first object among the objects based on a position in the area where the slide operation is detected by the operation detecting unit.

8. The electronic device according to claim 3,
wherein the display unit is configured to display a plurality of objects, and
the control unit is configured to specify, when an operation on a position in the area and the slide operation in a direction away from the position are detected by the operation detecting unit, the first object among the objects based on the position in the area.

9. The electronic device according to claim 1,
wherein the control unit is configured to causes the second object to be displayed on a display area of the display unit present in a slide direction by the slide operation farther than the first object.

10. The electronic device according to claim 9,
wherein the control unit causes the second object to be displayed on the display area adjacent to the first object.

11. The electronic device according to claim 1,
wherein the control unit is configured to cause the second object to be displayed on the display unit until a given time is elapsed since a last operation is detected by the operation detecting unit after stating to cause the second object to be displayed,

12. The electronic device according to claim 1,
wherein the control unit ends a display of the second object when a slide operation in a direction opposite to the slide operation is detected by the operation detecting unit in a state in which the second object is displayed on the display unit.

13. An operation control method executed an electronic device including a display unit and an operation detecting unit, the operation control method comprising:
displaying a first object on the display unit;
detecting a slide operation by the operation detecting unit; and
causing, when a slide operation is detected by the operation detecting unit while the first object is displayed on the display unit, a second object associated with a layer below the first object to be displayed on the display unit.

14. The operation control method according to claim 13,
wherein the electronic device further includes a housing having a first face, on which the display unit is arranged, and second and third faces interposing the first face therebetween, and
the operation detecting unit is arranged on the second face.

15. A non-transitory storage medium that stores an operation control program causing, when executed by an electronic device that includes a display unit and an operation detecting unit, the electronic device to execute:
displaying a first object on the display unit;
detecting a slide operation by the operation detecting unit; and
causing, when a slide operation is detected by the operation detecting unit while the first object is displayed on the display unit, a second object associated with a layer below the first object to be displayed on the display unit.
